(19) United States
(12) Patent Application Publication
(10) Pub. No.: US 2016/0283925 A1
(43) Pub. Date: Sep. 29, 2016

(54) OMNI-CHANNEL SHOPPING AND MOBILE PAYMENT SYSTEM

(71) Applicant: Kohl's Department Stores, Inc., Menomonee Falls, WI (US)

(72) Inventors: Ratnakar Lavu, Pewaukee, WI (US); Klarissa Marinetch, San Francisco, CA (US); Kiran Ramaraju, Menomonee Falls, WI (US)

(21) Appl. No.: 15/083,176

(22) Filed: Mar. 28, 2016

Related U.S. Application Data
(60) Provisional application No. 62/138,829, filed on Mar. 26, 2015.

(51) Int. Cl. G06Q 20/12; G06Q 30/06; G06Q 20/42; G06Q 20/32; G06Q 20/36; G06Q 20/40; G06Q 30/02; G06Q 20/20

(52) U.S. Cl. CPC G06Q 20/12; G06Q 30/0222; G06Q 30/0233; G06Q 30/0238; G06Q 30/0239; G06Q 30/0611; G06Q 30/0635; G06Q 20/20; G06Q 20/3227; G06Q 20/3276; G06Q 20/363; G06Q 20/401; G06Q 20/42

(57) ABSTRACT

An omni-channel or multi-channel shopping and mobile payment system and method makes in-store checkout flow at a retail store smooth, efficient and intuitive to the customer to thereby improve the customer's experience as well as reducing an amount of time spent at the checkout by both the customer and retail store sales associate. The system and method can reduce long checkout lines during peak period and allow retail store sales associates to spend more time on the sales floor helping customers and increasing sales. A mobile wallet associated with each customer can be used as the mechanism to compute an order, determine and apply offers and loyalty rewards, and give the customer a single click checkout experience at a point-of-sale device in the retail store.

### CROSS-REFERENCE TO RELATED APPLICATION(S)

This application claims the benefit of U.S. Provisional Patent Application No. 62/138,829 filed Mar. 26, 2015, which is incorporated herein by reference in its entirety.

### TECHNICAL FIELD

The present application relates generally to mobile payment systems to provide a customer with a checkout experience at a point of sale.

### BACKGROUND

Mobile payment systems or wallets, such as Google Wallet®, MCX®, passbooks, etc., allow for customers in a brick and mortar store to use a mobile device to pay for items and/or provide loyalty card information at a point of sale terminal (e.g., a cash register, a kiosk, etc.) in the store. The mobile payment systems can scan or otherwise receive credit card information, loyalty card information, and/or other information via a mobile device and store the information so that it can be used at a later time for shopping at a brick and mortar store. However, the current payment systems provide for very little other services, other than payment at a checkout counter.

### SUMMARY

Various aspects of examples of the technology are set out in the claims. According to a first aspect, an omni-channel shopping and mobile payment system comprises a customer profile database for storing customer identifier information; a cost estimation module for calculating a cost for a customer based on items chosen by the customer for purchase; a loyalty module for determining loyalty reward points earned by the customer based on past purchases; an offers module for determining discount offers that may be applied to the items chosen by the customer for purchase; a wallet module for tracking and updating customer specific information, including offers available to the customer, customer payment methods and information, customer loyalty reward points, and the items chosen by the customer for purchase; and/or a security module for authenticating and authorizing the customer.

According to a second aspect, an omni-channel shopping and mobile payment method may comprise creating and/or updating a mobile wallet account associated with a customer; associating offers with the mobile wallet account; determining loyalty rewards based on the customer's past activity; associating the determined loyalty rewards with the mobile wallet account; receiving indications from multiple shopping channels to add items to a shopping cart associated with the mobile wallet account; receiving a checkout indication from a point-of-sale communication device; calculating a total cost of the items in the shopping cart based on the items in the shopping cart, associated offers, and determined loyalty rewards; and completing a sales transaction with the customer based on the total cost. The method may also comprise determining if the customer has an existing mobile wallet account and, if so, authenticating the customer, updating the mobile wallet account associated with the customer, and allowing the customer to update the mobile wallet account.

The step of associating offers may further comprise identifying special promotional offers associated with the customer, identifying special promotional offers based on a geographic location of the customer, identifying special promotional offers based on the customer's interests, sending a message listing the identified promotional offers to the customer, and/or allowing the customer to select desired promotional offers for use with a current shopping transaction. The step of determining loyalty rewards may further comprise assessing loyalty rewards earned based on past purchase activity of the customer, updating the mobile account to include newly earned loyalty rewards, receiving a message from the customer electing how to use the determined loyalty rewards, and/or sending a notification to the customer when loyalty rewards are about to expire. The step of receiving indications from multiple shopping channels may further comprise receiving indications from the customer to add items to a shopping cart associated with the mobile wallet account when the customer is not in a retail store; determining that the customer has entered a retail store, receiving indications from the customer to add items to a shopping cart associated with the mobile wallet account while the customer is in a retail store; and/or receiving indications from the customer indicating whether items added to a shopping cart associated with the mobile wallet account are in-store, from another store, and/or online and updating the shopping cart associated with the mobile wallet account based on the received indications. The step of receiving a checkout indication may further comprise receiving a list of all items in the shopping cart associated with the mobile wallet account, retrieving all offers associated with the mobile wallet account, calculating a cost of items in the shopping cart associated with the mobile wallet account and associated offers, sending the calculated cost of items to a point-of-sale device in proximity to the customer, and receiving a confirmation from the point-of-sale device that the customer has accepted the calculated cost.

### BRIEF DESCRIPTION OF THE DRAWINGS

Many aspects of the present technology can be better understood with reference to the following drawings. The components in the drawings are not necessarily to scale. Instead, emphasis is placed on illustrating clearly the principles of the present technology. For ease of reference, throughout this disclosure identical reference numbers may be used to identify identical or at least generally similar or analogous components or features.

FIG. 1 is an illustration of an omni-channel shopping and mobile payment system configured in accordance with an embodiment of the present technology.

FIG. 2 is a block diagram of a mobile device that utilizes a mobile payment application and system configured in accordance with an embodiment of the present technology.

FIG. 3 is a block diagram illustrating components of a server device for use in an omni-channel shopping and mobile payment system configured in accordance with an embodiment of the present technology.

FIG. 4 is a block diagram illustrating a process performed in an omni-channel shopping and mobile payment system configured in accordance with an embodiment of the present technology.

FIG. 5 is a block diagram illustrating a method for creating or updating a wallet account in accordance with an embodiment of the present technology.

FIG. 6 is a block diagram illustrating a method for determining offers to associate with a wallet account of a customer in accordance with an embodiment of the present technology.

FIG. 7 is a block diagram illustrating a method for assessing a number of loyalty points earned by a customer in accordance with an embodiment of the present technology.

FIG. 8 is a block diagram illustrating a method for adding items to virtual shopping carts of wallet accounts associated with customers in accordance with an embodiment of the present technology.

FIG. 9 is a block diagram illustrating a method for determining the cost of items in physical and virtual shopping carts and for performing a checkout procedure in accordance with an embodiment of the present technology.

### DETAILED DESCRIPTION OF THE DRAWINGS

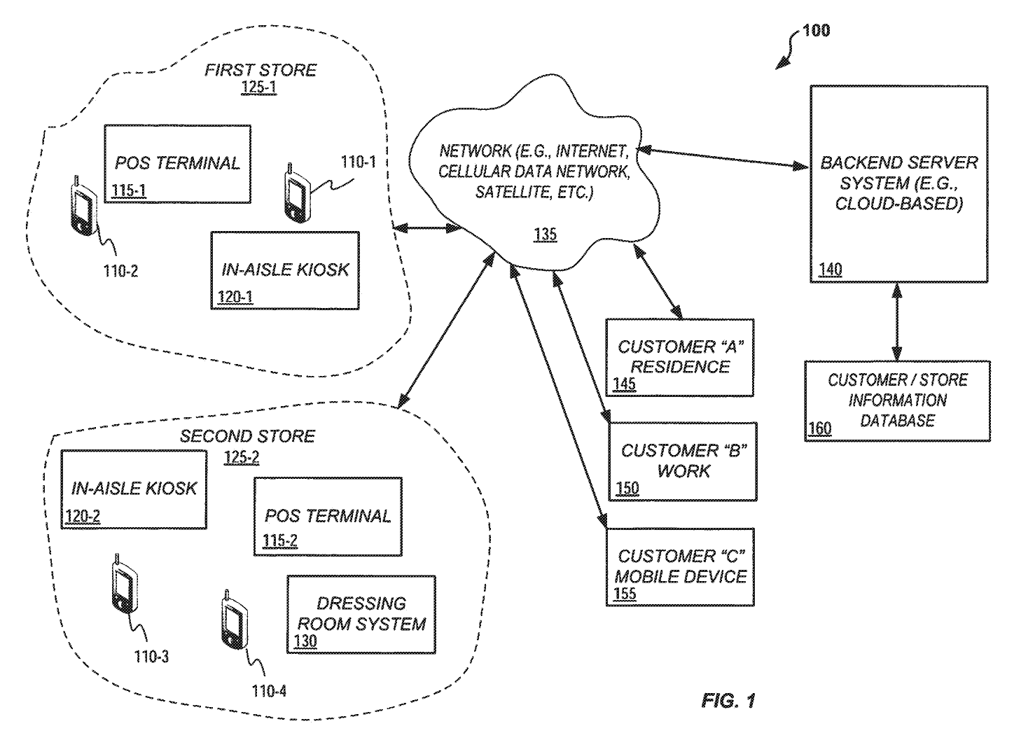

The present technology is generally directed to omni-channel shopping and mobile payment systems and associated methods. Systems described herein use mobile wallet accounts that are accessible through various channels to facilitate smooth, efficient, and intuitive in-store and online checkout for customers, thereby improving the customer experience as well as reducing the amount of time spent at the checkout by both the customer and a store associate. Various embodiments of the present technology may also enhance charge card usage and membership, and are thereby expected to increase overall profits to the store and/or parent company. Embodiments of the present technology may also reduce checkout lines and times during peak periods, and therefore allow store associates to spend more time on other tasks (e.g., on the sales floor helping customers and increasing sales). Specific details of several embodiments of the present technology are described herein with reference to FIGS. 1-9. Although many of the embodiments are described with respect to omni-channel shopping and mobile applications, devices, systems, and methods, other applications and other embodiments in addition to those described herein are within the scope of the present technology. Further, a person of ordinary skill in the art will understand that embodiments of the present technology can have different configurations, components, and/or procedures than those shown or described herein, and that these and other embodiments can be without several of the configurations, components, and/or procedures shown or described herein without deviating from the present technology.

FIG. 1 is an illustration of an omni-channel shopping and mobile payment system 100, referred to herein as “the system 100” configured in accordance with an embodiment of the present technology. The system 100 includes one or more store (brick and mortar) communication systems 125 including a first store communication system 125-1 and a second store communication system 125-2. The store communication systems 125 may include one or more in-store communication devices, such as a point-of-sale (POS) terminal 115, an in-aisle kiosk 120, a dressing room system 130, and in-store mobile devices (e.g., tablets or smartphones) operated by store employees. In the embodiment illustrated in FIG. 1, the system 100 includes a first POS terminal 115-1 and a first in-aisle kiosk 120-1 in the first store communication system 125-1, and a second POS terminal 115-2, a second in-aisle kiosk 120-2, and a dressing room system 130 in the second store communication system 125-2. In other embodiments, the system 100 can include only one store communication system 125 or more than two store communication systems 125, and each store communication system 125 can include one or more different in-store communication devices.

The various devices 115, 120 and 130 of the store communication systems 125 may be configured to communicate with each other, a store server system, which may be embodied in any one of these devices 115, 120 or 130, or in an independent store server (not shown). The POS terminals 115, the in-aisle kiosks 120, and the dressing room system 130 are also configured to communicate with customer mobile devices 110, such as smartphones and tablets. As shown in FIG. 1, first and second mobile devices 110-1 and 110-2 are shown to be communicating in the first store communication system 125-1, and third and fourth mobile communication devices 110-3 and 11-4 are shown to be communicating in the second store communication system 125-2.

The store communication systems 125, the POS terminals 115, the in-aisle kiosks 120, and the dressing room systems 130 are also configured to communicate directly with a backend server system 140, via a network 135, or indirectly with the backend server system 140 through one or more of the other in-store devices via the network 135. The backend server system 140 may be a single location or one of many locations (e.g., regional locations), and can be configured to coordinate mobile payments, related processes, and other processes described herein. The network 135 may include one or more of the Internet, an intranet, cellular data networks, satellite networks, etc.

Each of the mobile devices 110 can communicate data to the backend server system 140 via the network 135. For example, the mobile devices 110 can communicate data that relates to physical items selected that are added to a physical shopping cart at one of the stores 125 and/or virtual items that are added to a virtual shopping cart of the system 100 at any of the in-store devices (e.g., the POS terminals 115, the in-aisle kiosks 120, and/or the dressing room system 130). This data can be integrated at the backend server system 140 to create a combined shopping cart (including virtual and/or physical items selected by each customer) that can be maintained for each customer.

In addition to being able to select virtual and/or physical items in each of the store communication systems 125, customers may be able to select virtual items to add to a shopping list or cart via other channels outside of the store communication systems 125. For example, a customer “A” associated with the first mobile device 110-1 may select items, via the Internet (e.g., from a website associated with or managed by the retail establishment), to add to the shopping list or cart from a personal computer, tablet, and/or other communication device 145 at a residence of customer “A”. Similarly, a customer “B” may add items to the shopping list associated with Customer “B” via a computer or other communication device 150 at a work place of Customer “B,” and/or a customer “C” may use a mobile device 155 that is outside of the in-store communication systems 125 to add items to his or her shopping list. The backend server 140 can maintain the selections received from any of the possible channels in association with the individual customer and, therefore, the mobile payment system 100 can provide an omni-channel mobile payment system for each customer. That is, the mobile payment system 100 can preserve a listing of customer selections regardless of the channel from which they are received (e.g., physical or virtual in-store channels and virtual out-of-store channels). The individual customer may then combine all the items selected via any channel when the customer checks out at any of the in-store payment devices, such as the POS terminals 115, any of the in-aisle kiosks 120, or any dressing room systems 130 in any store 125.

The system 100 illustrates a single backend server system 140 and two store communication systems 125. In other embodiments, the system 100 may include multiple backend server systems 140 working collectively using methods described below to coordinate the shopping activity at any number of store communication systems 125, any customer mobile devices 110, residence communication devices 145, work communication devices 150, and/or other types of customer mobile devices 155.

As further shown in FIG. 1, the backend server system 140 is coupled to a store/customer information database 160 that may store customer-related information and store related information. For example, the store/customer information database 160 can store the items selected by each customer in a list associated with the customer (e.g., a customer or wallet account), regardless of the channels from which the selections were received. Accordingly, the system 100 allows a customer's selections from multiple channels (e.g., in-store physical selections, out-of-store virtual selections, etc.) to be stored at a central location, which allows the information to be retrieved quickly. In addition, the store/customer database can also include a memory that includes store information, such as sales, inventories, backordered items, etc. This information can be accessed to coordinate sales activity between stores. For example, a customer in communication with the first store communication system 125-1 may be allowed to select an item that is only available at the second store communication system 125-2 while the customer is at the first store. Specific features related to memory, servers, and databases for use with the system 100 are described in further detail below.

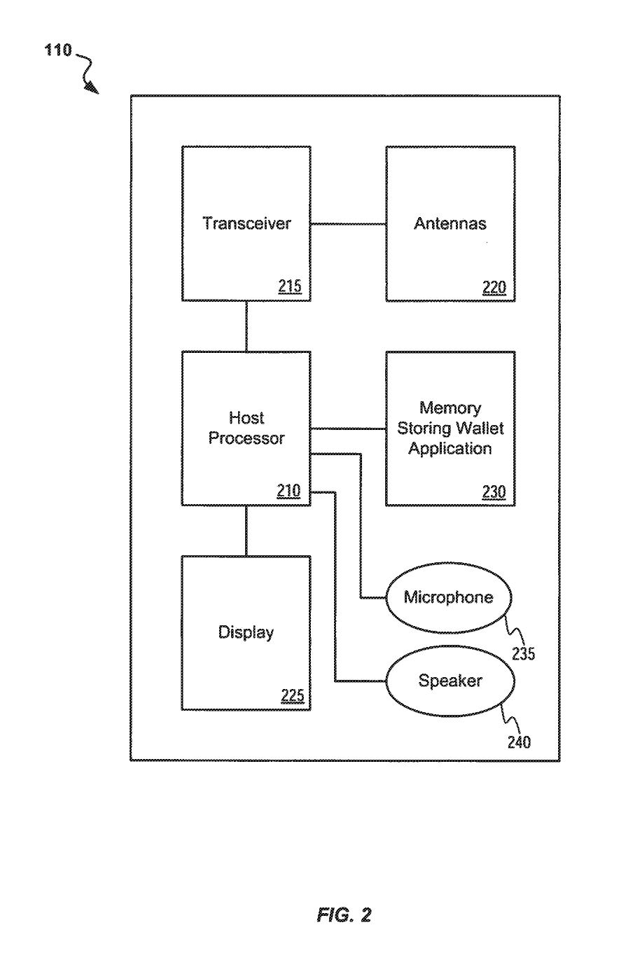

FIG. 2 is a block diagram of a mobile device 110 that can utilize the system 100 of FIG. 1 in accordance with an embodiment of the present technology. Referring to FIG. 2, the mobile device 110 may include a processor 210, a memory 230, a transceiver 215, and one or more antennas 220. The mobile device 110 may also include a display 225, a microphone 235, a speaker 240, and/or other suitable types of user interfaces and/or input and output devices. For example, the mobile device can include a camera for imaging or “scanning” a bar code label or other data on a physical product, as described below. The mobile device 110 and its components may comprise suitable logic, circuitry, interfaces, and/or code that may be operable to perform at the least the functions, operations, and/or methods described herein.

The one or more antennas 220 may enable the mobile device 110 to transmit and/or receive signals (e.g., RF signals, Bluetooth signals, etc.) via a wireless or wired communication medium. The antennas 220 may include one or more transmitting antennas and/or one or more receiving antennas. For example, the antennas 220 can enable the mobile device 110 to communicate with various aspects of the system 100 (FIG. 1) using the network 135, which can include the Internet, a cellular data network, a satellite, and/or other suitable connection means. Connectivity to the Internet may include, but is not limited to, long range wireless connections, short range wireless connections, and various wired connections including, but not limited to, telephone lines, cable lines, power lines, and the like.

The mobile device 110 may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, RFID, Near Field Communication (NFC), and/or other suitable communications means. The mobile device 110 involved in implementing various embodiments of the present invention may communicate using various media including, but not limited to, radio, infrared, laser, cable connection, and the like.

The above-described components allow the mobile device 110 to send and/or receive various messages to and/or from other devices within a network (e.g., the network 135 of FIG. 1). The processor 210 and/or other processors along with circuitry/elements operably coupled to the processor 210 may include instructions for detecting RFID and/or NFC tags and executing program code/parameters to generate sensory feedback.

The mobile device 110 may be, but is not limited to, an electronic user device in the form of a mobile telephone, a smartphone, a combination personal digital assistant (PDA) and mobile telephone, a PDA, an integrated messaging device (IMD), a notebook computer, a tablet, and/or other type of mobile computing device. The mobile device 110 may be stationary or mobile (e.g., carried by an individual who is moving). The mobile device 110 may also be located in a mode of transportation including, but not limited to, an automobile, a truck, a taxi, a bus, a train, a boat, an airplane, a bicycle, a motorcycle, and/or other mode of transportation. In certain embodiments, the mobile device 110 may send and receive calls and messages and communicate with service providers to a base station or other network device (via a wireless connection).

The memory 230 may include a computer-readable memory including removable and non-removable storage devices including, but not limited to, Read Only Memory (ROM), Random Access Memory (RAM), compact discs (CDs), digital versatile discs (DVD), etc. The memory 230 can include one or more program modules, such as a mobile wallet application or “App,” that perform particular tasks related to the system 100 (FIG. 1) and as described in further detail below. For example, the processor 210 can execute program modules, such as computer-executable instructions, associated data structures, and program modules to perform steps of the methods disclosed herein.

The processor 210 can be configured to control overall operation and/or configuration of the mobile device 110. The processor 210 can also be configured to execute one or more applications, such as SMS for text messaging, electronic mailing, audio and/or video recording, and/or other software applications (e.g., a calendar and/or contact list). The processor 210 may receive information from various input device, such as the display 225, the microphone 235, and/or the speaker 240. The processor 210 may also receive information from other electrical devices, such as the transceiver 215, or host devices that are communicatively coupled to the mobile device 110. The processor 210 can be configured to provide this information to various output devices, such as the transceiver 215, the display 225, the microphone 235, and/or the speaker 240.

The display 225, the microphone 235, and/or the speaker 240 can define a user interface of the mobile device 110 capable of receiving user input and providing information output to the user. For example, when the mobile device 110 is a mobile telephone, the microphone 235 can be used for receiving voice data from the user, and the speaker 240 can be used for presenting voice data to the user. The microphone 235 and speaker 240 can also be configured for receiving and confirming verbal commands. The display 225 can be configured as a touch-screen display, an alphanumeric keypad, a mouse, and/or another suitable input/output device. The mobile device 110 can receive user-provided information via one or more of the input devices, such as receiving information that is typed by a user on an alphanumeric keypad, receiving information that is typed or selected by the user on the touch-screen display, receiving information that is selected by the user with the mouse, and/or through other methods of receiving user input. Information can be provided to the user by displaying the information on the touch-screen display 225 or through other method of conveying and/or displaying information.

The transceiver 215 can be configured to send and receive electrical signals via the antenna 220. In general, the transceiver 215 can be configured to encode information, such as voice or data, onto a carrier wave and send the encoded signal via the one or more of the antennas 220 to another device within the network (e.g., the backend server 140 of FIG. 1, the in-store communication devices of FIG. 1, etc.). Upon receipt, the recipient device can decode the information from the carrier wave. In a similar manner, the transceiver 215 can be configured to receive an encoded signal via the one or more antennas 220, decode the information (e.g., voice and/or data) from the encoded signal, and communicate the decoded information to the processor 210 for processing and/or presentation to the user.

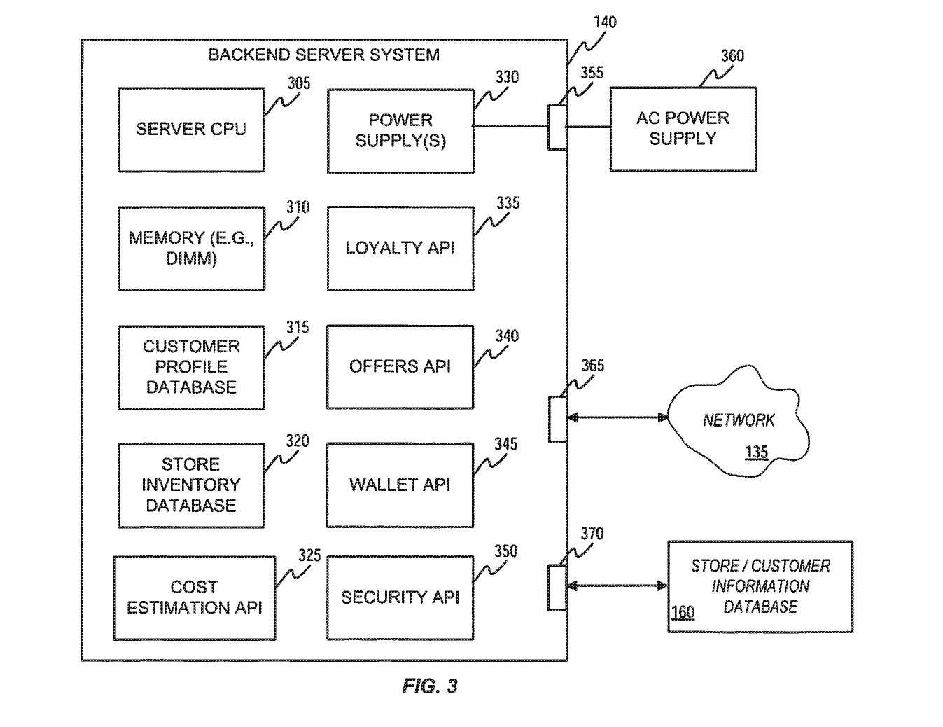

FIG. 3 is a block diagram illustrating components of a backend server system 140 that may be used in the system 100 of FIG. 1 in accordance with an embodiment of the present technology. The server device 140 includes a server processor 305, a memory 310, and one or more power supplies 330. The processor 305 may be configured to perform various processes using other components or modules of the server device 140 to perform the methods described below. Exemplary processors can refer to, without limitation, electronic circuits, systems, modules, subsystems, sub modules, devices and combinations thereof, such as Central Processing Units (CPU's), microprocessors, microcontrollers, processing units, control units, tangible media for recording, and/or a combinations thereof. The memory 310 may be configured to store data derived from the processor 305, as well as data received from the mobile devices 110, POS terminals 115, in-aisle kiosks 120, dressing room systems 130, residence computers 145, work computers 150, and/or other mobile devices 155 of the system 100 (FIG. 1).

The power supply 330 may be coupled to an external AC power supply 360 via a power interface 355. In other embodiments, the power supply 330 may include one or more batteries or power storage cells that allow the server device 140 to be decoupled from the AC power supply 360, at least temporarily. In this embodiment, the server device 140 is configured as a remote cloud device.

The memory 310 may include, but is not limited to, memory devices, data storage devices, and a combination thereof, such as memory chips, semiconductor memories, Integrated Circuits (IC's), non-volatile memories or storage device such as flash memories, Read Only Memories (ROM's), Erasable Read Only Memories (EROM's), Electrically Erasable Read Only Memories (EEROM's), Erasable Programmable Read Only Memories (EPROM's), Electrically Erasable Programmable Read Only Memories (EEPROM's), an Electrically Erasable Programmable Read Only Memory (EEPRO), volatile memories such as Random Access Memories (RAM's), Static Random Access Memories (SRAM's), Dynamic Random Access Memories (DRAM's), Single Data Rate memories (SDR's), Dual Data Rata memories (DDR's), Quad Data Rate memories (QDR's), microprocessor registers, microcontroller registers, CPU registers, controller registers, magnetic storage devices such as magnetic disks, magnetic hard disks, magnetic tapes, optical memory devices such as optical disks, compact disks (CD's), Digital Versatile Disks (DVD's), Blu-ray Disks, Magneto Optical Disks (MO Disks), and/or combinations thereof. In various embodiments, the memory 310 is configured as an integral part of the processor 305. In other embodiments, the memory 310 comprises a flash storage module (fixed or removable) and/or any other suitable non-volatile recording media module (e.g., optical, magnetic, etc.) operably coupled to the processor 305.

The processor 305 may be used in conjunction with various software and/or hardware modules to perform the methods described below. For example, the processor 305 can generate analytical models used to analyze data indicative of the shopping cart selections, spending habits, stores frequented by customers, and/or other information that are is received from the mobile devices 110 and/or any of the other customer communication devices 145, 150 and 155 outside of the store communication systems 125 (FIG. 1). In the embodiment shown in FIG. 3, the various software and/or hardware modules of the backend server system 140 include a customer profile database 315, a store inventory database 320, a cost estimation application program interface (API) 325, a loyalty API module 335, an offers API module 340, a wallet API module 345, and a security API module 350. The server device 140 also includes a network interface 365 coupled to the network 135, and an external database interface 370 coupled to the store/customer information database 160.

The customer profile database 315 may be used to store customer identifier information tied to specific customer wallet accounts, such as customer names, addresses, phone numbers, email addresses, customer identifier numbers (e.g., IDs, account numbers, etc.), usernames, passwords, and/or other information associated with customers. In addition, the customer profile database 315 may include profiles associated with loyalty programs that may be used by the loyalty API module 335 and special offers (e.g., rewards, gift certificates, discounts, gift cards, etc.) that may be used by the offers API module 340. The customer profile database 315 can also store additional information associated with customers' wallet accounts, such as items in a virtual shopping cart, payment methods (e.g., credit card information, online payment mechanisms, bank account information, etc.), and receipts from previous transactions at the retailer. Further details of these profiles are described below.

The store inventory database 320 may be a centralized database that is updated in real-time or near-real-time when transactions are completed at any of the store communication systems 125 and/or online via any of the mobile devices 110 or customer computers 145, 150 or other mobile devices 155. The store inventory database 320 can associate each store communication systems 125 with item identifiers (e.g., stock keeping units (“SKU”)) for items sold in the store and the quantity of each item. During operation, the store inventory database 320 may be queried by the first store communication system 125-1 (FIG. 1) about a specific item to determine where within the system 100 (FIG. 1) the item is available if the item is not available at the first store. For example, the store inventory database 320 can indicate that the desired item is located at another physical store. In addition to identifying stores where specific inventory is located, the store inventory database 320 may associate inventory with warehouses storing the inventory for delivery to stores and/or to customers (e.g., via an online order through the Internet).

The cost estimation API module 325 can be configured to calculate the checkout cost for a customer when a customer chooses to purchase one or more items that have been previously saved into a shopping cart or basket on the customer's personal wallet (e.g., stored on the backend server system 140). The cost estimation API module 325 may retrieve all of the customer wallet contents, such as offers (e.g., discounts), loyalty points, personal or customer-specific offers (e.g., given the size of the virtual shopping cart or basket size, previous purchases, etc.), and compute the entire basket price with these discounts and/or offers applied. The total price as well as the discounts and/or offers applied to the virtual shopping cart can be displayed to the consumer (e.g., on the consumer's mobile device 110 (FIGS. 1 and 2)), thereby allowing the customer to review the price and to pay. The cost estimation API module 325 may provide mobile self-checkout capabilities to the customer in a dressing room system 130 (FIG. 1), an in-aisle kiosk 120 (FIG. 1), the consumer's mobile device 110 (FIG. 1), and/or any other mobile browse kiosks or communication devices enabled at different locations within the store.

In various embodiments, the cost estimation API module 325 may compute the order total using the specific in-store price based on a store number passed to the cost estimation API when the customer is checking out. The cost estimation API module 325 may also apply a charge card associated with the customer wallet account (stored on the customer profile database 315 and/or the mobile wallet API 345), offers and coupons chosen to be applied by the customer, and/or offers and coupons automatically chosen by the cost estimation API module 325, and determine an estimated cost response based on this information. The estimated cost response can then be sent to the POS system (e.g., the POS terminal 115 (FIG. 1), etc.) where the customer is checking out to render the preview order screen for the customer. The estimated cost response may also be sent to a mobile device 110 associated with the customer. The cost estimation API module 325 can operate as a total value system that computes the total cost of items in the shopping basket based on current running promotions, user payment method, etc. Further details of actions performed by the cost estimation API module 325 are described below.

The loyalty API module 335 can be configured to determine the loyalty points/rewards that a customer has earned by past purchases. The information tracked by the loyalty API module 335 for a given customer may include a loyalty points balance, profile status (e.g., active or inactive), membership start date, total points in member lifetime, point thresholds (e.g., a point total when next reward is available), earning period (i.e., time since last reward), credit/debit card cash identifier, credit/debit card cash balance, credit/debit card cash effective start date, credit/debit card cash effective end date, a list of past transactions (e.g., including transaction identifiers and transaction dates), store identifiers (e.g., store names and/or store numbers) where transactions were performed, types of transactions, earned points with the transaction, lists of rewards, a loyalty identifier (used to obtain the reward details), rewards dates, rewards descriptions, event type of the non-transaction/rewards, earned points, and/or credit/debit card cash coupons awarded. Details of how the loyalty API module 335 uses this information are described in further detail below.

The offers API module 340 determines offers (e.g., specials, targeted items, marketing campaign items, etc.) that may be offered to a customer. The offers may be targeted to a single customer based on a customer profile, past purchases, known interests, etc. The offers may also be based on customer groups. The groups may be store-based, geographic location-based, age-based, interest-based, gender-based, and/or associated with other parameters that may define a group of consumers. Offers can be chosen and presented in multiple ways. For example, determining which offers to present can be made based on the user's buying habits, the user's current geographical location, the user's residence location, a recent life event (e.g., a birthday, the addition of a new member to the family, the purchase of a home, a graduation, etc.), or some other context-based item or event.

The wallet API module 345 can serve as the user interface between the backend server system 140 and the customer via POS systems (e.g., the POS terminal 115, the in-aisle kiosk 120, and/or the dressing room systems 130 (FIG. 1)) and the customer devices (e.g., the mobile devices 110, the residence computer 145, the work computer 150, and/or the other mobile devices 155). The wallet API module 345 can track which items a customer has placed in his or her wallet for purchase (e.g., whether the item be physically scanned and placed in the consumer's physical shopping cart or placed into a virtual shopping cart). The wallet API module 345 also serves as an intermediary between the customer and other modules in the backend server system 140. For example, the wallet API module 345 can direct messages received from the store communication systems 125 (FIG. 1) and/or the customer device to the appropriate module (e.g., the customer profile database 315, the store inventory database 320, the cost estimation API module 325, the loyalty API module 335, the offers API module 340 and the security API module 350). In certain embodiments, for example, the wallet API module 345 may retrieve a virtual shopping cart created by the customer via many channels (e.g., physical shopping cart, in-store virtual shopping cart, online virtual shopping cart, etc.), and this information can then be communicated to an in-store POS (e.g., the POS terminal 115 (FIG. 1) to allow the consumer to checkout in a store. Other details of functions performed by the wallet API module 345 are described below.

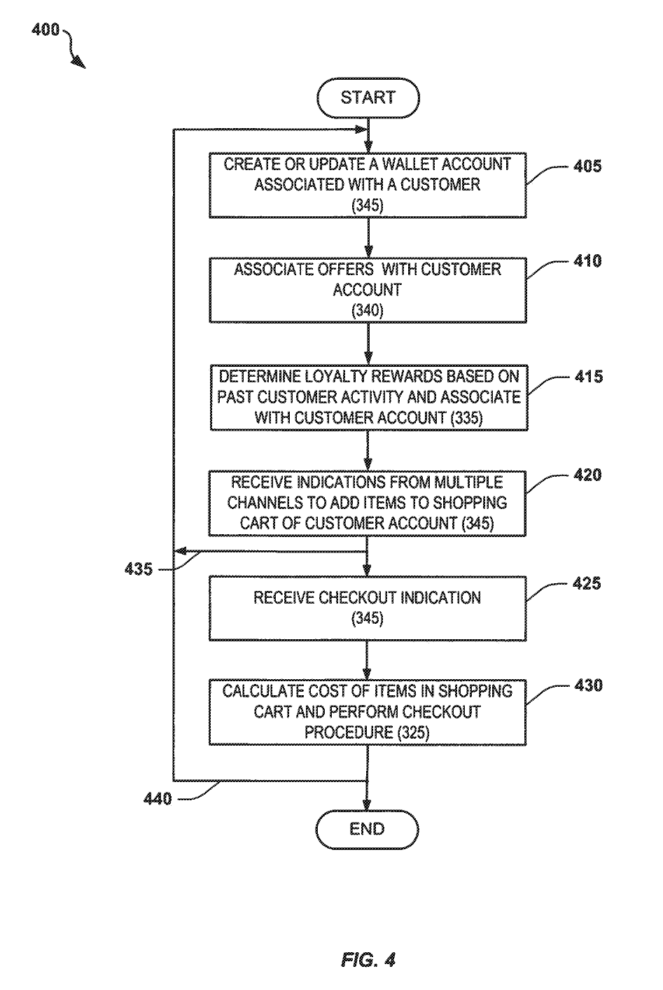

The security API module 350 performs authentication, authorization, and/or encryption functions for the backend server system 140. Details of the functions performed by the security API module 350 are described below with reference to FIGS. 4-9.

In certain embodiments, the system 100 can be operated or managed by a single entity, such as a single retailer or a parent company with two or more retailers. Accordingly, the rewards, offers, gift cards, and/or loyalty programs used in conjunction with the wallet accounts can all be associated with the single retailer or parent company. While the system 100 and the mobile accounts associated therewith can be accessed through multiple channels (e.g., mobile applications, POS terminals, points of commerce, retailer websites, etc.), the single entity can control the management of all aspects of the omni-channel shopping and mobile wallet experience thereby providing a continuous, harmonious, and unambiguous experience for a user where the user understands that a single company or brand is associated with all aspects of the omni-channel shopping and mobile wallet experience.

In various embodiments, the offers API module 340, the wallet API module 345, and/or other aspects of the backend serve system 140 are integrated with third parties to provide an “open” wallet that allows third-party generated offers (e.g., rewards, discounts, coupons, etc.) to be added to customers' wallet accounts. For example, third party vendors can be allowed to communicate with the backend server system 140 to push coupons for the retailer to the customer's wallet account (e.g., stored on the customer profile database 315). In this manner, outside vendors (e.g., RetailMeNot.com, etc.) can provide customers with offers or rewards for use at the retail establishment (e.g., online or in-store). In still further embodiments, the backend server system 140 can be integrated with social networking channels (e.g., Facebook, Twitter, etc.) to allow offers to be pushed to the consumer's wallet account via social channels. The integration with third party social networking channels also allows the retailer (i.e., the operator of the system 100) to push offers to social networking accounts of known customers (e.g., customers with wallet accounts) to increase customer engagement with the retailer. Thus, the offers API module 340, the wallet API module 345, and/or other aspects of the backend server system 140 access APIs from third party sites to pull offers from those sites and integrate them into the mobile wallet.

In various embodiments, the system 100 (as described in FIGS. 1-3) can be configured to provide a “touchless” shopping and payment experience in which customers can use the mobile wallet application 230 to pay for items purchased in a physical store and/or online. For example, while shopping at a physical store, the user can scan or image a bar code or other machine readable data associated with each product to create a virtual shopping cart on the user's mobile device 110, which reflects items in her physical shopping cart. Thus, the user can easily keep a running tally or total of purchases in her physical cart, where the mobile wallet applies all applicable taxes, and discounts, credits and other price adjustments to provide an accurate total.

During checkout at a POS device in a store (e.g., the POS terminal 115), a sales associate and/or the customer can scan, via the POS device, physical items selected for purchase by the customer (e.g., in the customer's physical shopping cart). The customer can communicatively connect his or her mobile device 110 to the POS device by “scanning” a QR code and/or other suitable machine-readable code at the POS device with the camera of the mobile device 110. The wallet application 230 on the customer's mobile device 110 can use the scanned code to connect the mobile device 110 to the POS device. In other embodiments, the mobile device 110 and the POS device can be communicatively coupled using other suitable means (e.g., near field communication).

After all of the physical items have been scanned at the POS device, the customer can view the items selected for purchase (i.e., in a physical and virtual shopping carts) using the wallet application 230 on the mobile device 110. The items can include not only physical items from the store (selected then or purchased online then picked up in the store), but also virtual items that were previously selected for purchase from another store or online via a device within the store (e.g., an in-aisle kiosk 120, a dressing room system 130, etc.) and/or a customer device outside of the store (e.g., a customer computer 130, 145 or mobile device 155). Accordingly, the shopping cart shown on the wallet application 230 includes items from multiple different shopping channels. In addition, the itemized shopping cart can display the various rewards and/or offers applied to the purchase.

As discussed above, the offers API 340 can be configured to automatically select the rewards and/or offers in the customer's wallet account (stored on the customer profile database 315) such that the customer receives the lowest price or best deal on the items in the shopping cart. If desired, the customer can remove, add, and/or modify the items in the shopping cart and the rewards/offers applied to the transaction, and the wallet application 230 can update the total price of the transaction accordingly. Once these modifications are complete, the customer can elect to checkout via the wallet application 230. For example, the customer can select a “pay” option on the mobile application 230, and the mobile application 230 can apply a previously uploaded method of payment to the purchase to complete the purchase. Accordingly, the system 100 allows customers to shop via multiple channels (e.g., online and in-store), and complete purchases via mobile devices 110 in a virtually touchless transaction. Indeed, the only time a store employee is involved in the system is when the physical items are scanned at the POS device. In further embodiments, the system 100 is configured such that the customer can scan physical items himself/herself using his or her mobile device 110 and/or an in-store device (e.g., an in-store kiosk, dressing room system, etc.) and connected to the mobile device 110. In this embodiment, the system 100 is completely touchless in that the system 100 allows consumers to check out on their own in a physical store. The receipts (provided on the wallet application 230 of the mobile device 110) can be reviewed by a store employee upon leaving the store to prevent fraud.

The system 100 can operate in a similar manner for online shopping on a website. For example, after the customer has selected the items he or she wishes to purchase from the retailer website, the customer can scan a code (e.g., a QR code, a bar code, an alphanumeric code, etc.) on the website with the customer's mobile device 110 to connect the mobile device 110 (and the wallet application 230 thereon) to the POS or point of commerce device, which in this case is a personal computer, tablet, or other device through which the retailer website can be accessed. In other embodiments, the POS device and the mobile device 110 can be connected using other suitable means. Once the POS and the mobile device 110 are connected, the items in the consumer's shopping cart can be displayed, along with the various rewards that can be applied to the purchase. The customer can then continue the checkout process via the mobile device 110 by editing the items in the cart and selecting the method(s) of payment to complete the purchase.

In certain embodiments, the system 100 allows customers to connect individual wallet accounts stored on the customer profile database 315. For example, family members and/or friends can elect to share their wallet accounts so that one customer can use offers or reward items in another customer's wallet account. In certain embodiments, a group of customers (e.g., members of the same family) can share their wallet accounts such that all gift cards and/or offers available in one wallet account are available to all others connected to the wallet account. In other embodiments, wallet accounts can be connected, but only selected items in the wallet account of one customer are shared with the wallet account of the other customer. For example, a first customer can selectively connect a first wallet account to a second wallet account associated with a second customer, and the first customer can send the second customer selected gift cards, offers, rewards, wish lists, and/or other items stored in the first customer's wallet account. The recipient of the selected wallet item can receive a notification when something has been added to the recipient's wallet account. For example, the recipient can receive an email or a notification via the wallet application 230 on the recipient's mobile device 110.

The system 100 can also include a messaging feature such that selected wallet items (e.g., a gift card, a discount, etc.) can be sent to connected wallet accounts with a person message, photo, and/or video, and the recipient of the selected wallet item can respond with a personal message, photo, and/or video. These messages can be sent and received from the wallet application 230 on the customer's mobile devices. For example, a parent can send a rewards gift card from his or her wallet account to the wallet account associated with his or her child, and include a message explaining what the child should purchase with the gift card (e.g., “for grandma's birthday present,” “for a prom dress,” “whatever you want,” etc.). The child can then respond with a message (e.g., “thanks, mom”), a photo (e.g., a picture of the purchase), and/or a video. In certain embodiments, the connected wallet accounts allows a group of connected wallet accounts to make a group purchase such that an item can be purchased using offers or gift cards from multiple wallet accounts. The customers can select which rewards, offers, or gift cards from their individual wallet accounts can be used for the purchase of an item (e.g., a wedding or baby registry item for a friend or family member), and the selected rewards, offers, or gift cards can be applied to the purchase of the item when one of the customers purchases the item (using his or her own wallet account).

FIG. 4 is a block diagram illustrating a process 400 performed by an omni-channel shopping and mobile payment system configured in accordance with an embodiment of the present technology. For example, the process 400 can be performed by the system 100 of FIG. 1. As a person of ordinary skill in the art would appreciate, the process 400 of FIG. 4 and other processes described herein may be modified. For example, the processes described herein may be modified by omitting steps, rearranging steps, and/or dividing steps into sub-steps. Various details of the process 400 of FIG. 4 will be described with reference to the different components of the system 100 of FIG. 1 and the backend server system 140 of FIG. 3. However, the process 400 may be performed with other suitable omni-channel shopping and mobile payment systems.

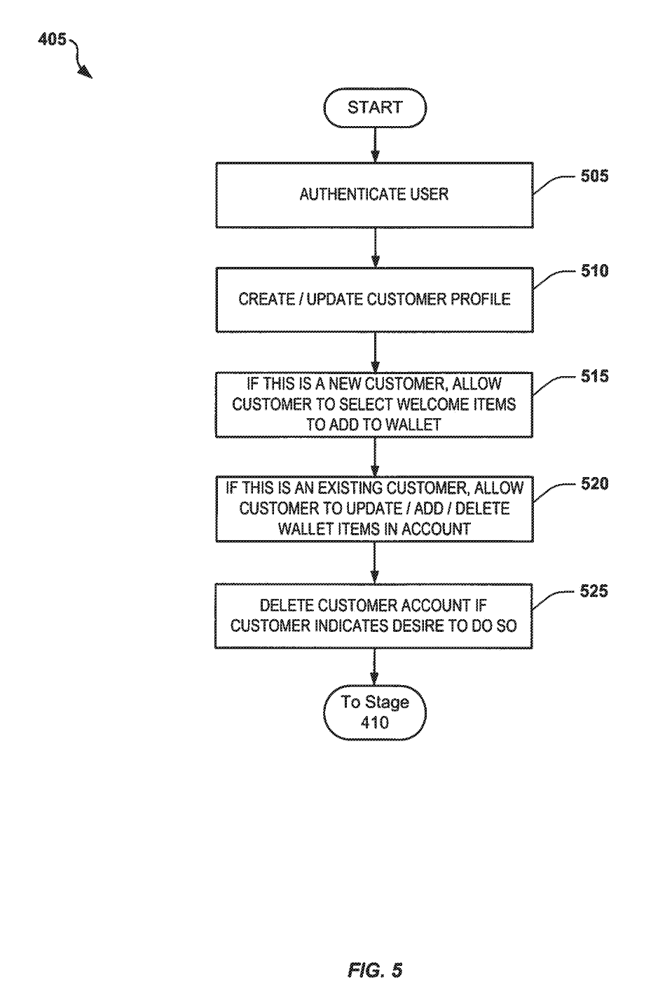

As shown in FIG. 4, the process 400 may begin by creating or updating a wallet account associated with a customer (block 405). For example, the mobile device 110 (FIG. 1) can send a create request signal or an update request signal over the network 135 to the backend server system 140 indicating that a customer wishes to create or update a wallet account associated with the customer. Upon receiving the create request signal at the backend server system 140 (FIG. 1), the wallet API module 345 (FIG. 3) may initiate a process to create a wallet for a new wallet customer. Upon receiving the update request signal at the backend server system 140 (FIG. 1), the wallet API module 345 (FIG. 3) may update settings of an existing wallet customer. An embodiment of a process for creating or updating a wallet account (block 405) is shown in FIG. 5.

As shown in FIG. 5, when the signal received by the backend server system 140 (FIG. 1) at step or block 405 (FIG. 4) corresponds to an update request signal for an existing customer, the security API module 350 (FIG. 3) can authenticate the existing wallet customer using a hashcode contained in the update request signal and/or other suitable means for authenticating the existing customer account. The hashcode may be generated by the mobile device 110 (FIG. 1) using known information associated with the customer. For example, the hashcode may be generated using a customer ID (e.g., an identification number and/or username), a first name of the customer, a last name of the customer, and/or a known salt code. In various embodiments, the update request signal may include the hashcode as well as the customer ID, the first name, and the last name that was used to generate the hashcode. The update request signal may also include a timestamp of when the hashcode was generated. The security API module 350 (FIG. 3) can use the customer ID, the first name, the last name, and/or the known salt code associated with the customer to re-generate the hashcode. If the re-generated hashcode matches the hashcode in the update request signal, then the security API module 350 (FIG. 3) confirms authentication, and the process 405 of FIG. 5 may proceed. In other embodiments, the user can be authenticated using other suitable authentication means. If the authentication fails, the process 400 (FIG. 4) may terminate.

When the customer is a new customer, as indicated in the create request signal, the authentication of the user (block 505) may be omitted. The user authentication step (block 505) may also be omitted when the customer request corresponds to gifting a wallet item (e.g., an electronic gift card) to another person.

Upon completing a successful user authentication (block 505), the process 405 proceeds to block 510 where a customer profile or wallet account is created and/or updated. When a new wallet account is being created, various different types of information can be added to the new customer profile/wallet account. For example, the new customer profile information may include user-related information, including the customer's first and last name (e.g., obtained automatically from the mobile device 110) and a retail user ID that is created for that particular customer (e.g., a user ID associated with the customer on a backend database of the retail establishment). Other customer profile information may also be obtained from or created for the customer at block 510. For example, the customer profile information may include one or more of the customer's email address, birthday, postal code, phone number, address, loyalty point balance, status (active or inactive), member since date, life time loyalty points, point threshold of next loyalty reward, earning period, cash card and/or credit card balance, cash card and/or credit card number, cash card and/or credit card effective start date, cash card and/or credit card effective end date, and/or a list of transactions at the retailer or group of retailers. Each transaction may include various pieces of information associated with the customer's transactions, such as a transaction ID (e.g., a number or other code associated with and unique to the transaction), a transaction date, a store identifier, an event type, points earned for transaction, rewards earned for transaction, a reward ID, cash coupons, cash coupon number, cash coupon balance, cash coupon effective start date, cash card effective end date, and/or other information associated with the transaction.

If the customer is a new customer, the process 405 continues by allowing the customer to select certain welcome items selected for new customers (block 515). The welcome items may include reward points, cash coupons, categories of interest, and/or other items to customize his or her mobile wallet application. If the customer is an existing customer, this step may be omitted.

If the customer is an existing customer, the customer may selectively update, add, and/or delete items from his or her wallet (block 520). For example, the customer can add rewards that have been selected (e.g., by the backend server system 140 (FIG. 1) for the customer, gift cards, and/or other items. The rewards may be special offers (e.g., discounts, credits, etc.) on certain items in the store locations where the customer shops, special offers for certain retail establishments frequented by the consumer, reward points or gift cards earned based on previous transactions of the customer, special offers selected based on categories of interest associated with the customer, and/or other suitable rewards.

In various embodiments, the customer can add the rewards to the wallet by entering information from physical rewards (e.g., received in the mail, on a receipt, etc.) and/or virtual rewards received via email. For example, the customer can enter a reward identifier (e.g., an alphanumeric code) associated with the reward using a keypad or touch screen on the customer's mobile device 110 (FIG. 1) and/or another device communicatively coupled to the mobile device 110. When the reward identifier is a barcode, QR code, and/or other type of scannable code, the customer may use a camera and/or other feature on the mobile device 110 (FIG. 1) to upload the reward to the wallet. The backend server database 140 can receive the reward identifier (alphanumeric or scannable code), associate the code with a specific reward, add that reward to the customer's backend customer profile/wallet account on the customer profile database 315 (FIG. 3), and allow the customer to view the reward on the wallet application 230 (FIG. 2) on the customer's mobile device 110 (FIG. 1). In other embodiments, the customer can push virtual rewards received via email directly to his or her mobile wallet application 230 (FIG. 2) and/or the backend customer profile database 315 (FIG. 3) without entering or scanning a reward code to the mobile device 110 (FIG. 1). For example, the email with the virtual reward can include a button or link that, when activated, pushes the reward into the customer's wallet (i.e., uploads the reward to the backend server system 140 (FIG. 1)).

In further embodiments, the rewards are automatically pushed to the customer's wallet without the customer needing to take any further action. For example, when the backend server system 140 (FIG. 1) determines that a reward (e.g., a coupon, discount, gift certificate, loyalty points, etc.) should be given to a particular customer, the backend server system 140 can automatically push (i.e., transmit) that reward to the customer's wallet account (e.g., stored on the customer profile database 315 (FIG. 3)) and transmitted to the wallet application 230 (FIG. 2) of the customer's mobile device 110 (FIG. 1). As discussed above, in various embodiments, the backend server system 140 allows integration with third parties (e.g., third party vendors, social media channels, etc.), and these third parties can automatically push offers to the customer's wallet account. In certain embodiments, a notification is sent to the customer each time a reward is pushed to the customer's wallet account. For example, the wallet application 230 (FIG. 2) on the customer's mobile device 110 (FIG. 1) can provide a notification to the consumer that a new item has been added to the customer's wallet account, such as a pop-up notification across the home screen of the mobile device 110 (FIG. 1) or an indicator within the wallet application 230 (FIG. 2). The backend server system 140 (FIG. 1) can also or alternatively send the customer an email notifying the customer of the update.

In various embodiments, the wallet API module 345 (FIG. 3) may receive a signal from the mobile device 110 indicating that the customer wishes to delete their wallet account (block 525). If the wallet API module 345 (FIG. 3) receives this delete account signal, the wallet API module 345 sets the status parameter in the customer's profile to inactive.

In certain embodiments, the system 100 (FIG. 1), in conjunction with the wallet API 345 (FIG. 3) can be configured to automatically create customer wallets in the customer profile database 315 (FIG. 3) without the customer needing to create the wallet himself or herself and, therefore some or all of the steps of the process 405 of FIG. 5 can be omitted. For example, rather than the wallet being created when the customer signs into the system 100 (FIG. 1) for the first time through an online channels (e.g., via a mobile device 110, computer, etc.), the backend server system 140 is created automatically for every known customer of the retail establishment. Known customers can be identified by their first names, last names, loyalty card identifiers, email addresses, data from a credit card for the retailer that the user applied for, and/or other information that is provided to the backend server system 140 (FIG. 1) when a customer makes a purchase at any one of the various purchasing channels (e.g., in store purchase, online purchase, smart phone application, etc.). The backend server system 140 (FIG. 3) can include a master data management (“MDM”) tool (e.g., stored in the memory 310 and operated by the server CPU 305) that identifies the known customers and automatically creates a wallet for each customer stored on the customer profile database 315. Any rewards (e.g., coupons, discounts, gift cards, etc.) that the customer receives when shopping online or in a physical store can be associated with that customer's online wallet. That is, the backend server system 140 (via the MDM tool) can receive information regarding a transaction at a store or online that includes one or more of the customer's name, email address, loyalty card identifier, and/or other identifier, and associate any rewards received during that transaction with the wallet created for that customer. Accordingly, the system 100 (FIG. 1) can automatically push rewards into a customer's wallet, even though the customer has not signed into the walled application 230 (FIG. 2). When the customer does access the wallet application 230 (FIG. 2) for the first time (e.g., by downloading the application to his or her mobile device 110), the customer already has a mobile wallet created for him or her, which is stored in the customer profile database 315 (FIG. 3) on the backend server system 140. All of the rewards the customer has received based on past purchases and/or general offers are already associated with the customer's mobile wallet and, therefore, the customer can automatically access the rewards without needing to manually enter any information.

Referring back to FIG. 4, the process 400 can continue by the offers API module 340 associating offers with the wallet account of the customer (block 410). Offers may include specials, also known as promotional offers or special promotional offers, such as reduced prices for products, buy one get one free offers, cash rewards, cash cards, gift cards, etc. The offers may be selected for specific customers or for groups of customers.

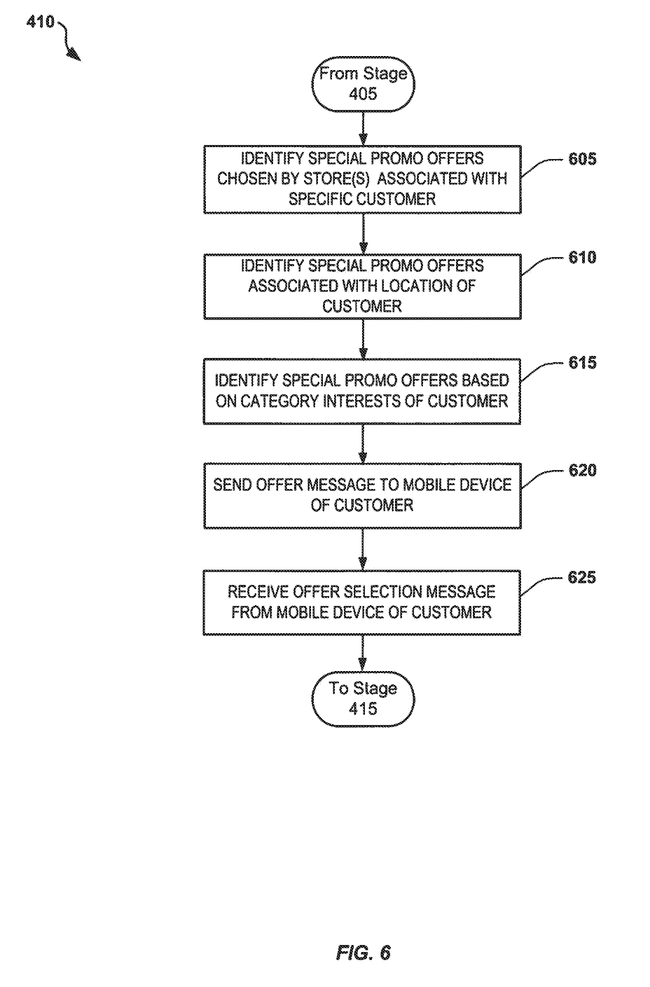

FIG. 6 illustrates a block diagram of a method 410 for determining offers to associate with a wallet account in accordance with an embodiment of the present technology. These steps can be performed by the offers API module 340 (FIG. 3) of the backend server system 140. The method 410 can include identifying special offers chosen by or for a specific store or stores associated with the customer (block 605). The store-specific offers can be for one or more physical stores in the vicinity of the customer's home address, work address, other location frequented by the customer, and/or actual location (e.g., as identified by the customer's mobile device 110 (FIG. 1)) and/or stores where a customer has shopped in the past. By allowing specific stores to select the special promo offers, individual stores may choose items in order to reduce inventory of overstocked items, eliminate inventory of items going out of season, or simply to attract business during slow times. In various embodiments, the store-specific offer selected by an individual store may be associated with an item that the customer has placed in his or her physical shopping cart and/or added to his or her wallet's virtual shopping cart. For example, item-specific offers may be provided if a customer has placed a threshold amount of items (virtual and/or actual) into his or her wallet account cart for purchase.

In addition to targeting individual customers with special promo offers (block 605), the offers API module 340 (FIG. 3) may also identify special promo offers associated with a current location of the customer (block 610). The current location of a customer may be determined by the individual store communication system 125 (FIG. 1) detecting the presence of the customer's mobile device 110 (FIG. 1) via Wi-Fi, Digby, nearfield communication, and/or other communication system, by the customer specifying his or her own location manually via the mobile device 110, and/or by the mobile device 110 sending location information to the backend server system 140. These location-based offers allow the backend server system 140 to simultaneously send the same offers to multiple customers in the same store and/or group of stores, as opposed to individually targeting specific customers. In further embodiments, the offers API module 340 may also identify groups of customers to send special promo offers based on past locations of customers. The past locations of customers may be indicative of locations where the customers frequent in their daily commutes, other periodic activities, and/or travels.

At block 615, the offers API module 340 may identify special promo offers to send to customers based on one or more categories of interest stored within the customer profile database 315 (FIG. 3). The categories of interest in a customer profile may be chosen by the customer (e.g., via the mobile wallet application 230 (FIG. 2)) and/or chosen automatically by the offers API module 340 based on products purchased by the customer in previous transactions within the system 100 (FIG. 1; e.g., within the network of the retail establishment). The categories of interest may include types of clothing, kitchen products, home decoration products, sports-related products, tools, gardening, plants, toys (e.g., types of toys, toys for certain age groups, etc.), home care products, health care products, books, and/or other categories. In certain embodiments, the offers API module 340 can provide consumers with offers or rewards using other suitable parameters, such as customer demographics.

In various embodiments, the offers API module 340 can filter or remove offers identified by the offers API module 340 at any of blocks 605, 610 and/or 615 if an individual customer already has an identical offer is already in his or her wallet. For example, the offers API module 340 can reconcile the existing offers in individual customer wallets based on the individual customers profiles stored in the customer profile database 315 (FIG. 3), and only push or otherwise transmit a new offer to the individual customer wallets if the customer profile does not contain the identical offer.

At block 620, the offers API module 340 (FIG. 3) creates offer messages to send to individual customer mobile devices 110 (FIG. 1) regarding one or more of the offers identified at blocks 605, 610 and 615. The offer information included in the offer messages may include a product identifier or ID, a product description, an effective start date, an effective end date, a value of the offer (e.g., cash value of a gift card, rewards card, etc.), and/or a type code indicating the type of offer. For example, the offers could be directed to a product or specific set of products, or the offers could be generic offers for a specified time period (e.g., a certain day, date range, time of day, etc.). The offers could also be specific to information related to the consumer, such as a birthday offer. Some of this offer information may be omitted for some offers. For example, the effective start date and effective end date may be omitted for offers that do not expire, such as cash cards and/or gift cards. The value information may be omitted for promo offers, such as price reductions, buy one get one free offers, etc. The information in the offer message may also include variables indicating whether or not the offer is shareable and/or giftable to other customers. A shareable offer may be selected by a first customer to be shared with a second customer. A giftable offer (e.g., a gift card) may be purchased by a first customer and given to another customer. The first customer can share or gift an offer with another customer by selecting the shareable/giftable offer via the mobile wallet application 230 (FIG. 2), and the system 100 (FIG. 1) via the backend server system 140 can transmit this offer to the selected customer by transferring the offer to the selected customer's mobile wallet profile stored on customer profile database 315 (FIG. 3) and/or sending the selected customer an email with the shared/gifted offer.

The offer messages created at block 620 are sent to mobile devices 110 (FIG. 1) of customers. In addition to sending messages regarding new offers, the offers API module 340 may also create and transmit offer messages to customers' mobile devices 110 (FIG. 1) that serve as reminders or notification messages informing a customer that an offer in their wallet is about to expire or has expired.

Subsequent to sending the offer messages (block 620), the wallet API module 345 (FIG. 3) receives selection messages from mobile devices 110 of customers accepting or selecting specific offers to add to their wallets (stored on the customer profile database 315) and/or to share or gift to another customer's wallet. In various embodiments, some or all offers identified by the offers API module 340 for a specific customer may be automatically selected for activation in the customer's wallet account (stored on the customer profile database 315 (FIG. 3)), and no selection by the customer is required. In addition to receiving offer selection messages at block 620, the wallet API module 345 (FIG. 3) may receive offer deletion messages from the mobile devices 110. Upon receipt of an offer deletion message, the wallet API module 345 deletes a selected offer in a customer's profile. The various aspects of the method 410 of FIG. 6 (blocks 605-625) may be performed periodically (e.g., on a daily basis, a weekly basis, a monthly basis, etc.), when a customer location changes, when a customer enters a store, automatically as soon as offers become available, and/or based on other criteria.

Referring once again to FIG. 4, the process 400 continues by determining, via the loyalty API module 335 (FIG. 3), loyalty rewards based on past customer activity and associating the loyalty rewards with the customer's wallet account stored on the customer profile database 315 (FIG. 3) (block 415). The loyalty rewards may be determined on a real-time basis as purchases are made by a customer or periodically (e.g., weekly, monthly, etc.). The loyalty rewards are typically based on a number of loyalty points earned by a customer, and loyalty points are typically based on a dollar amount spent by the customer at the retail establishment and/or related retail establishments. For example, one loyalty point may be awarded for each dollar spent. Loyalty rewards may be in the form of a dollar amount (e.g., gift certificates used for later purchase) or may be used to purchase products. For example, two dollars of loyalty rewards cash may be credited automatically to a customer's wallet account for every 100 dollars spent by the customer. Alternatively, a customer may be able to purchase a product, cash card, and/or gift card for a predetermined number of loyalty points. Loyalty reward points may have an expiration date, such as a number of weeks, months, or years after the loyalty rewards points are earned. In some embodiments, loyalty points are awarded only in specific locations. In these embodiments, only customers that live in the specific locations may qualify to receive loyalty rewards.

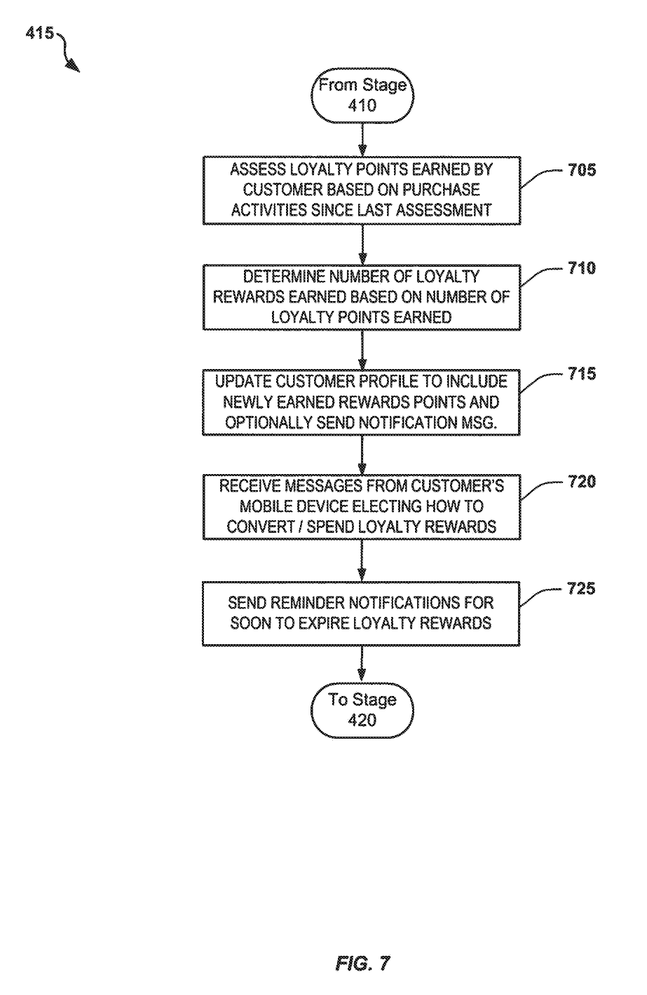

FIG. 7 illustrates a block diagram of a method 415 for determining loyalty rewards associated with a wallet account in accordance with an embodiment of the present technology. These steps can be performed by the loyalty API module 335 (FIG. 3) of the backend server system 140. At block 705, the loyalty API module 335 (FIG. 3) assesses the number of loyalty points earned by a customer. The loyalty points earned may be associated with a dollar amount spent by the customer. For example, one loyalty point may be earned for each dollar spent. The assessment at block 705 may be made on a real-time or near real-time basis as the customer purchases products with his or her wallet account. Alternatively, the assessment may be made on a periodic basis (e.g., weekly, monthly, etc.) and the purchases since the last periodic assessment are considered.

At block 710, the loyalty API module 335 (FIG. 3) determines the number of loyalty rewards points (e.g., corresponding to dollars that can be spent at the store) earned based on the assessed number of loyalty points earned by the customer. The number or loyalty rewards points earned may be a fraction of the number of loyalty points earned. For example, a customer may earn a certain percentage of loyalty rewards points for each loyalty point earned, such as, for example, 0.5%, 1.0%, 1.5%, 2.0% etc.

At block 715, the loyalty API module 335 (FIG. 3) updates a customer profile (stored on the customer profile database 315 (FIG. 3)) to include the newly earned rewards points. Optionally, the loyalty API module 335 (FIG. 3) may create a notification message (block 715) and the notification message may be sent by the wallet API module 345 to the mobile device 110 (FIG. 1) of the customer informing the customer of the newly earned points. The rewards points may be automatically converted to cash rewards dollars in the customer profile (stored on the customer profile database 315 (FIG. 3)). Cash rewards dollars can be spent by the customer to make future purchases. Alternatively, the rewards points may be used by the customer to convert to cash cards or gift cards.

At block 720, the wallet API module 345 (FIG. 3) receives one or more election messages from a customer's mobile device 110 (FIG. 1) electing how to convert or spend the loyalty rewards points. These election messages may be part of a checkout process as performed at stage 430 (FIG. 4) and described below. Alternatively, these election messages may be independent of other purchases made by the customer.

At block 725, the loyalty API module 335 (FIG. 3) creates reminder notification messages to remind customers of soon to expire loyalty rewards points. For example, notification messages may be sent one month prior to expiration, one week prior to expiration and/or one day prior to expiration. The notification messages may be sent by the wallet API module 345 (FIG. 3). At the conclusion of the method 415, the process 400 may proceed to stage 420.

Referring once again to FIG. 4, at block 420, the wallet API module 345 (FIG. 3) receives indication messages from one or more customer devices to add items for eventual purchase to the virtual shopping cart of the wallet account associated with the customer. The indication messages may be received from multiple channels, including the customer's mobile devices 110 (FIG. 1), the residence computers 145 (FIG. 1), the work computers 150 (FIG. 1), and/or the other mobile devices 155 (FIG. 1). For example, the customer may place items in the virtual shopping cart by scanning or otherwise identifying a physical item selected at a store with the customer's mobile device 110 (FIG. 1), selecting an item for purchase on a mobile application via the mobile device 110, and/or selecting an item for purchase from an online site associated with the store (e.g., via a personal computer). Accordingly, the wallet API module (FIG. 3) can receive indication messages from customer devices while the customer is in a physical store 125 (FIG. 1) associated with the system 100 (FIG. 1) and/or when the customer is outside of a physical store 125 associated with the system 100. When the customer is within the store, the customer device (e.g., the mobile device 110 (FIG. 1)) can communicate directly with the backend server system 140 (FIG. 1) or indirectly with the backend server system 140 via the store communication system 125 (FIG. 1). When the customer is outside of the physical store, the customer device can communicate directly with the backend server system 140 (FIG. 1) via the network 135 (FIG. 1). In addition, the indication messages may be received from one or more in-store locations via the store communication systems 125 (FIG. 1). For example, the indication messages can be received from a POS terminal 115 (FIG. 1; e.g., when a sales associate scans or otherwise identifies an item for purchase), an in-aisle kiosk 120 (FIG. 1), a dressing room system 130 (FIG. 1; e.g., when a customer selects a specific item to be added to the virtual shopping cart from an online site or store application), and/or other in-store device.

In response to receiving these indication messages, the wallet API module 345 updates customer profile stored on the customer profile database 315 (FIG. 3) associated with the customer to indicate the items added to the virtual shopping cart of the wallet account. In various embodiments, the communications or sessions between the customer devices and the backend server system 140 (FIG. 1) in which the items are added to the virtual shopping carts can be authenticated, via the security API 350 (FIG. 3), using an authentication protocol, such as the authentication protocol discussed above (e.g., an MD5 message-digest algorithm).

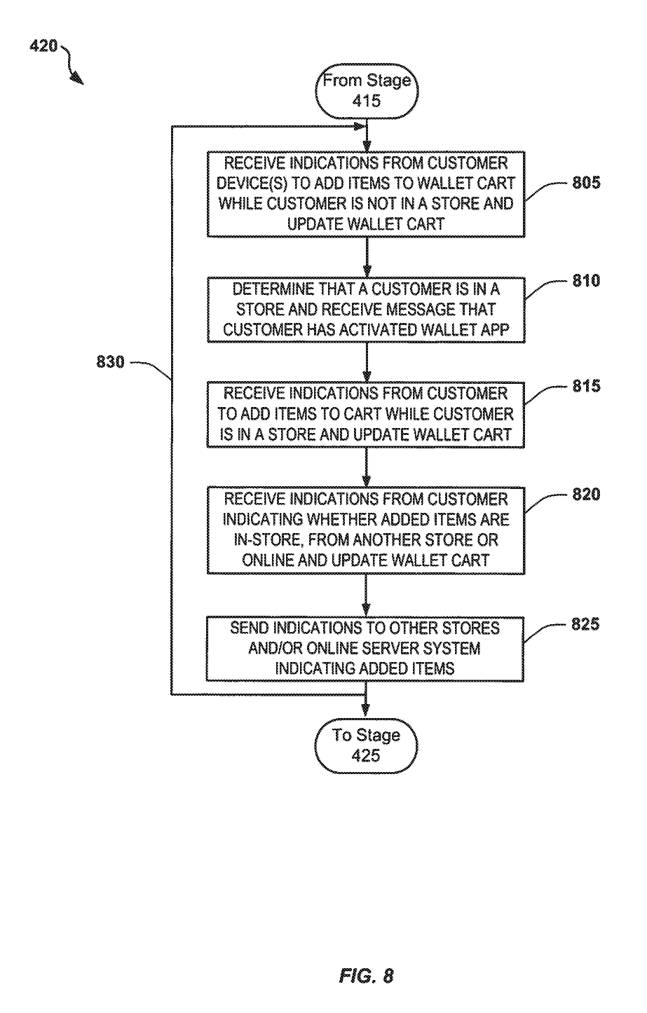

FIG. 8 illustrates a block diagram of a method 420 for adding items for purchase to virtual shopping carts of wallet accounts associated with customers in accordance with an embodiment of the present technology. These steps can be performed by the wallet API module (FIG. 3) of the backend server system 140, and the contents of each customer's virtual shopping cart can be saved to the associated customer profile stored on the customer profile database 315 (FIG. 3). At block 805, the wallet API module 345 (FIG. 3) receives indications to add items to a virtual shopping cart associated with a customer profile. These indications can be received from one or more customer devices (e.g., mobile devices 110 (FIG. 1)) associated with a customer having a wallet account. The indications received at block 805 are received directly from the customer device (via the network 135 (FIG. 1)) while a customer is not in a physical store or at least not in communication with one of the store communication system 125 (FIG. 1). These indications contain information indicating to add items for eventual purchase to the wallet account of the customer (stored on the customer profile database 315 (FIG. 3). For example, the add-item indication information may include a product identifier (e.g., a product name, alphanumeric code, scannable code, etc.), an offer associated with the product, a wallet account ID or identifier, and/or a customer name. Upon receiving the add-item indications, the wallet API module 345 adds the virtual item and/or information associated with the virtual item (e.g., special offers associated with the item) to the virtual shopping cart of the customer profile associated with the customer's wallet account in the customer profile database 315 (FIG. 1).

At block 810, the wallet API module 345 (FIG. 3) determines whether the customer is in a specific store and, if so, receives an in-store indication message that the customer has activated a wallet application 230 (FIG. 2; also referred to as a wallet “App”) on a mobile device 110. The message indicating the customer has activated the wallet application 230 (FIG. 2) may be received directly from the mobile device 110 (FIG. 1) or from the store communication system 125 (FIG. 1) with which the mobile device is communicating (e.g., via an in-aisle kiosk 120 (FIG. 1), a POS terminal 115 (FIG. 1), a dressing room system 130 (FIG. 1), and/or some other communication device within the store communication system 125). The wallet API model 345 (FIG. 3) can receive the in-store indication message when the customer opens the wallet app 230 (FIG. 2) on the mobile device 110 (FIG. 1) within the store. In other embodiments, wallet API model 345 (FIG. 3) can receive the in-store indication message automatically when the customer's mobile device 110 (FIG. 1) is detected by the store communication system 125 (FIG. 1). That is, the customer does not need to actively open the wallet application 230 (FIG. 2) for the wallet API module 345 (FIG. 3) to determine that the customer is in a store. The in-store identification message may also include a store identifier to allow the wallet API 345 (FIG. 1) to determine that the customer is in the specific store and/or a specific location within the store.

While in a physical store, the mobile device 110 (FIG. 1) may communicate with, or at least be detected by, one or more of beacons (e.g., Bluetooth low energy protocol beacons), a geo-fence system, a video banner or signage within the store that displays offer information with which the mobile device 110 may communicate, an in-store Wi-Fi or ZigBee network, a type of wayfinding technology (e.g., a magnetic field or Bluetooth), the in-aisle kiosks 120 (FIG. 1), POS terminals 115 (FIG. 1), dressing room systems 130 (FIG. 1), and/or other communication device in the store communication system 125 (FIG. 1). For example, when a customer comes within the range of a beacon in a store, the store communication system 125 (FIG. 1) may send the mobile device 110 (FIG. 1) a message or notification to determine that the customer is within the store and/or the customer's position within the store. In various embodiments, the notification can include offer information (e.g., for discounts or promotions in the store), product information (e.g., for specific products in the store), and/or other suitable information. Once the store communication system 125 (FIG. 1) determines that the customer is within the store, the store communication system 125 may communicate this information to the wallet API module 345 (FIG. 3) via the network 135 (FIG. 1).

After the wallet API module 345 (FIG. 3) has determined that the customer's mobile device 110 (FIG. 1) are in a specific store, the wallet API module 345 may receive one or more indication messages to add more items to the wallet account of the customer. These in-store add-item indications may be received directly from the customer's mobile device 110 (FIG. 1), via the network 135 (FIG. 1), or indirectly from any of the communication devices in the store communication system 125 (FIG. 1) with which the mobile device 110 is interacting (e.g., any of the in-aisle kiosks 120, POS terminals 115, dressing room systems 130, or other communication device).

In certain embodiments, for example, the customer may go to any in-store communication device (e.g., a POS terminal 115 (FIG. 1), an in-aisle kiosk 120 (FIG. 1), a dressing room system 130 (FIG. 1), etc.) with a physical shopping cart containing physical items for purchase at the store. The mobile device 110 (FIG. 1), with the active wallet application 230 (FIG. 2), may communicate with the store communication device via various wireless technologies (e.g., Bluetooth, near field communication, etc.). The user and/or a sales associate may scan or otherwise identify the items in the customer's physical shopping cart with a scanner or other device at the store communication device. The user may also or alternatively take photos of barcodes of the physical items or otherwise identify the physical items with the mobile device 110 (FIG. 1), and the mobile device 110 can communicate the barcodes and/or other item identifier information to the store communication device. For example, the mobile device 110 (FIG. 1) can automatically push the item identifier information to the store communication device or the customer can selectively do so, via the wallet application 230 (FIG. 2), after one or more items have been scanned. Once the in-store communication device receives the item identifier information, the in-store communication device can communicate with the backend server system 140 (FIG. 1) to add the item information to the customer's virtual shopping cart stored on the customer profile database 315 (FIG. 3).

In other embodiments, the customer may go directly to an in-aisle kiosk 120 (FIG. 1), a dressing room system 130 (FIG. 1), and/or other in-store customer communication device, and activate a search function of the device where the customer can select items to add to the customer's virtual shopping cart. The search function may be similar to an Internet browser search engine, and may allow the customer to search for items in a specific department or category (e.g., women's clothing, baby items, sports gear, etc.) or to search all departments. The search function of the in-store device may be constrained to search for items in-stock in the specific store where the customer is present, or the search function may include a search for items in-stock in other stores and/or available from warehouses (e.g., via an online purchase). When a customer wants to purchase an item that is in the store where the customer is present, the customer can locate the item (e.g., using directions obtained from the search function) and puts the item in the customer's physical shopping cart to be scanned or otherwise processed at checkout. In other embodiments, the customer can select the item for purchase, and this information can be sent to an in-store communication system accessible by a sales associate such that the sales associate can obtain the item from within the store and bring it to the customer and/or to the point of sale. In further embodiments, the selected item can include an identifier that is associated with a hold condition in which only the customer can purchase the selected item. For example, the identifier (e.g., a bar code) associated with the selected item can be communicated to the store communication system 125 (FIG. 1) and/or the backend server system 140 (FIG. 1), associated with the customer's virtual shopping cart, and only released for purchase when the customer identifies himself or herself (e.g., via the mobile application 230 (FIG. 1)) at a point of sale.

When a customer wants to purchase an item that is online or in another store, but not in the store where the customer is present, the store communication device and/or the wallet application 230 (FIG. 2) running on the mobile device 110 (FIG. 1) may send a signal to the backend server system 140 (FIG. 1) to add that item to the customer's wallet account. The store communication device may then communicate the item identifier to the wallet API module 345 (FIG. 3) (block 815). In addition, the store communication device may communicate information indicating how the purchase is to be completed to the wallet API module 345 (block 820). For purchases in another store, the purchase completion options may include placing the item on hold and allowing the customer picking up the item at the other store, shipping the item to the customer from the other store, and/or shipping the item from the other store to the store where the customer is present for later pickup. For online purchases, the items may be shipped to the customer's home address or another address identified by the customer. Other delivery options may be available. After the wallet API module 345 (FIG. 3) has received the indications of whether the item being purchased is at another store or online (block 820) the wallet API module 345 (FIG. 3) sends indications to the other stores and/or an online server system such that the other stores or the online server system is aware that one of their items has been reserved for purchase (block 825).

At the completion of the stages in FIG. 8, no items have been purchased, but the selected items have been added to the customer's wallet account virtual shopping cart (stored on the customer profile database 315 (FIG. 3) and/or the wallet application 230 (FIG. 2)) for purchase at checkout. As indicated by the arrow 830, the steps of the method 420 (blocks 805-825) may continue to be performed for a specific customer until that customer chooses to checkout and pay for the items in the virtual shopping cart and in the customer's physical shopping cart.

Referring once again to FIG. 4, steps 405 through 420 of the method 400 and any related actions described in relation to the methods described in FIGS. 5, 6, 7 and 8, may continue, as indicated by the arrow 435, until the customer is ready to checkout and purchase items in the wallet account (e.g., in the customer's physical and virtual shopping cart).

At block 425, the wallet API module 345 (FIG. 3) receives a checkout indication from one of the store communication devices (e.g., any of the in-aisle kiosks 120, POS terminals 115, dressing room systems 130, and/or another communication device in the store communication system 125) with which the mobile device 110 (FIG. 1) of a customer is interacting (using the active wallet application 230 (FIG. 2) on the mobile device 110). The checkout indication message may include a customer ID, a store ID, and/or any necessary authentication information to authenticate the store communication device and/or the mobile device 110 (FIG. 1). Upon successfully authenticating the received checkout indication, the wallet API module 345 (FIG. 1) sends a customer wallet ID to the store communication device via the store communication system 125 (FIG. 1). The store communication device can use the wallet ID to initiate the cost estimation API module 325 (FIG. 3) to perform cost estimation and to perform other checkout procedures (block 430).

The cost estimation API module 325 (FIG. 3) calculates a cost of items selected for purchase in both the customer's physical shopping cart at the store (e.g., after the items have been scanned or otherwise identified at a point of sale device) and in the customer's virtual shopping cart stored in the customer profile database 315 (FIG. 3) (block 430). Calculating the cost may include an interactive session between the cost estimation API module 325 (FIG. 3) and the customer via the wallet application 230 (FIG. 2) on the customer's mobile device 110 (FIG. 1). For example, the cost estimation API module 325 (FIG. 3) can automatically select all the items stored in the customer's wallet (“wallet items”), including items placed in the customer's virtual shopping cart and physical items scanned at the point of sale, and automatically select offers (received from the offers API 340 (FIG. 3)) and/or loyalty items (received from the loyalty API 335 (FIG. 3)) to utilize with the purchase. The cost estimation API 325 (FIG. 3) can select the applicable offers and loyalty items from the customer's wallet (stored on the customer profile database 315 (FIG. 3)) and/or from new offers or loyalty items received from the offers API 340 (FIG. 3) and/or the loyalty API 335 (FIG. 3). The new offers or loyalty items may be based on the items selected for purchase, the specific store location, and/or other suitable parameters. After this automatic selection, the customer may use the wallet application 230 (FIG. 2) on the customer's mobile device 110 (FIG. 1) to modify the automatic selections prior to final settlement. In other embodiments, the customer may user other in-store communication devices (e.g., in-aisle kiosks 120 (FIG. 1)) to modify the automatic selections prior to purchase.

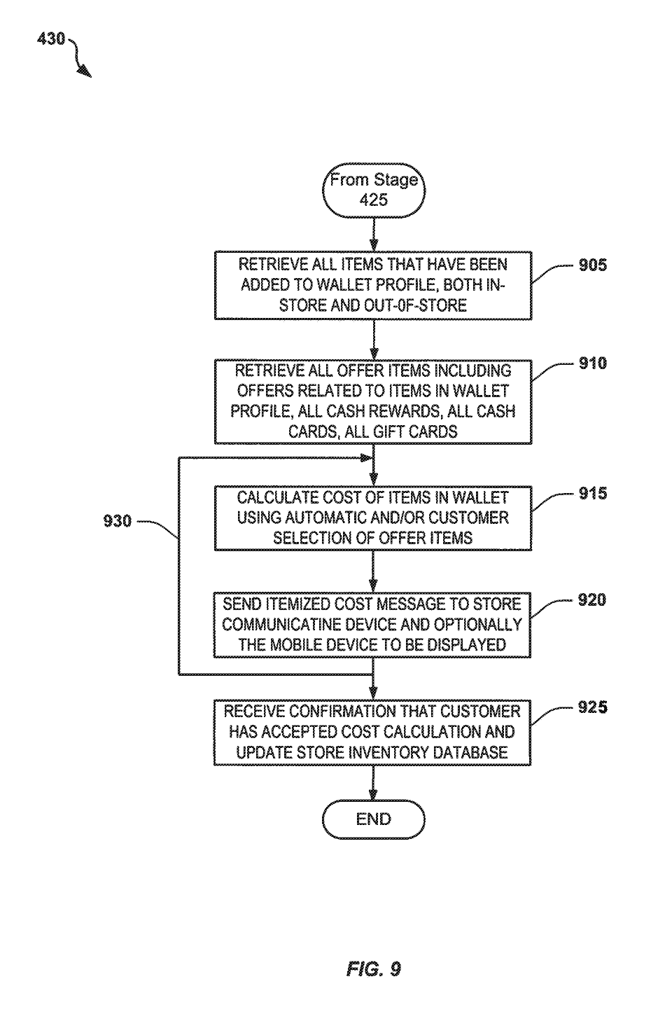

FIG. 9 illustrates a block diagram of a method 430 for method for determining the cost of items in physical and virtual shopping carts and for performing a checkout procedure in accordance with an embodiment of the present technology. At block 905, the cost estimation API 335 (FIG. 3) can retrieve items that have been added to the customer profile (e.g., a virtual shopping cart) of the customer's wallet (stored on the customer profile database 315 (FIG. 3)). The items in the customer's wallet can be added through the various channels discussed above (e.g., a physical shopping cart and/or a virtual shopping cart), and can include both in-store items and out-of-store items, including on-line items and items at other stores. In one embodiment, the store communication device interacts with the mobile device 110 (FIG. 1) to retrieve items stored in the active wallet application 230 (FIG. 2) of the mobile device 110 (FIG. 1) and/or on the customer profile database 315 (FIG. 3). For example, the customer can interact with any of the store communication devices (e.g., by touching a touchscreen user interface of the device and selecting to check out), and the mobile device 110 (FIG. 1) can communicate the stored items to the store communication device. In another embodiment, the items stored in the wallet may be retrieved by the wallet API module 345 (FIG. 3) from the backend server system 140 (FIG. 1) and communicated to the store communication device.

At block 910, all offer items and reward items stored in the customer's wallet are retrieved. These items may include all offers related to items that are currently stored in the customer profile in the customer profile database 315 (FIG. 3), all cash or loyalty rewards, all cash cards, all gift cards, and/or other offers or promotions. These offer and reward items may be retrieved by the store communication device from the wallet application 230 (FIG. 2) of the mobile device 110 (FIG. 1) and/or from the wallet API module 345 (FIG. 3) in a manner similar to that described in reference to retrieving the items selected for purchase.

At block 915, the cost estimation API module 325 (FIG. 3) calculates a cost of items in the virtual shopping cart of the customer's wallet. The cost estimation API module 345 (FIG. 3) at the backend server system 140 (FIG. 1) may perform the cost estimation and communicate the cost estimation to the store communication device in connection with the mobile device 110. In other embodiments, the store communication device (or a server device in the store communication 125 (FIG. 1) that is communicatively coupled to the store communication device) may internally perform the operation of the cost estimation API module 345 and provide a cost calculation.

The cost estimation API module 345 (FIG. 3) may automatically select offers to be used at checkout and, in certain embodiments, the offers may be selected or arranged in a manner to maximize the savings for the customer. In one embodiment, for example, the cost estimation API module 345 (FIG. 3) can prioritize a combination of offers, cash rewards, and/or gift cards when calculating the total cost during checkout. For example, in certain embodiments the prioritized combination may be as follows: first choose to apply cash rewards (e.g., loyalty rewards), then apply offers associated with items in the virtual wallet/shopping cart, and finally apply gift cards to the purchase. In other embodiments, the cost estimation API module 345 (FIG. 3) uses other prioritizations may be used.

In some embodiments, the number of cash rewards and offers that can be applied at checkout may be limited. For example, a customer may be limited to applying one or two cash rewards and/or offers at checkout. A customer may be limited to applying one offer for any one item being purchased. For example, if a customer's wallet has two offers for the same item, the customer may be limited to applying only one of the two offers.

In embodiments where the number of cash rewards and/or offers are limited, the cost estimation API module 345 (FIG. 3) may be configured to apply the limited number of rewards or offers such that the savings to the customer is maximized. Alternatively, the cost estimation API module 345 (FIG. 3) may be configured to apply those cash rewards and/or offers that are due to expire in the nearest term and/or within a threshold time period (e.g., within 1, 2, 3, 4 or more days, within 1, 2 or 3 weeks, etc.). In further embodiments, the cost estimation API module 345 (FIG. 3) can be configured to use a combination of the algorithms to select a combination of offers and rewards. In certain embodiments, the consumer can specify, via the consumer's profile stored on the consumer profile database 315 (FIG. 3), a prioritization or metric for applying the offers and rewards

Once the cost estimation API module 345 (FIG. 3) has determined which cash rewards, offers, and gift cards to apply to the transaction, the cost estimation API module 345 communicates information indicating this rewards/offers selection and the list of items in the wallet to be purchased to the store communication device and/or the mobile device 110 (FIG. 1) such that the information can be displayed to the customer (block 920). For example, the information can be displayed on the screen of the mobile device (FIG. 1) and/or the screen of the store communication device. The offers may be displayed in a manner such that the customer can easily see which item (or items) is associated with a particular offer. For example, the items in the shopping cart can be listed in an itemized manner with the associated offer or reward (and the associated price reduction) shown directly below or adjacent to the original item price. In addition, the cost estimation API module 345 (FIG. 3) may communicate information of all other available cash rewards, offers, and/or gift cards to the store communication device and/or the mobile device 110 (FIG. 1) such that this information can be displayed to the customer.

After the selected cash rewards, offers, gift cards, and items to be purchased are displayed to the customer, the customer may elect to change any of the cash rewards, offers, and gift cards if they desire. In addition, the customer may elect to remove any items from the virtual shopping cart. In certain embodiments, the customer may save items in the customer's profile for purchase at a later date. The customer changes may be made on a user interface of the store communication device and/or the mobile device 110 (FIG. 1) of the customer. If the customer elects to change the selected cash rewards, offers, and/or gift cards that are being applied, or elects to change the items to be purchased, the method 430 returns to block 915, as indicated by the arrow 930. The cost estimation API module 325 (FIG. 3) then recalculates the total cost of the transaction with the customer modifications taken into consideration. The functions performed at blocks 915 and 920 may repeat until the customer has finished modifying his or her rewards and shopping cart selections.

After the customer has finished changing cash rewards, offers, and gift cards, and removing and/or adding items to be purchased, the customer may select a method of payment for the balance due after application of all cash rewards, offers, and gift cards. In certain embodiments, the cost estimation API module 325 (FIG. 3) may automatically choose the payment option in a prioritized manner specified by the user or the backend system. For example, the cost estimation API module 325 (FIG. 3) may first elect to use a charge card affiliated with the store where the customer is present, then elect another type of charge card (e.g., Visa, MasterCard, American Express, Discover, etc.), and then apply other forms of payment (e.g., Apple Pay, Google Express, PayPal, debit card, etc.). The secondary and tertiary options may also be chosen in a prioritized manner. For example, the other charge cards and other forms of payment may each be chosen in the order in which they were added to the customer's wallet or, alternatively, may be chosen in a priority that the customer has chosen when setting up or updating their wallet account settings. The information necessary to process the various payment methods can be stored on the wallet application 230 (FIG. 2) and/or on the customer's profile in the customer profile database 315 (FIG. 3).

When the customer has finished selecting the method of payment, the customer, via the mobile device 110 (FIG. 1) and/or the store communication device, can confirm the cost calculation, and thereby pay for the order (block 925). The store communication device may print and/or send an electronic message (e.g., an email to the customer's email account or electronic notification to the wallet application 230 (FIG. 2)) with (a) an order confirmation for items being purchased from another store or online and/or (2) a receipt for items being purchased in-store. At this time, the store communication device communicates a sale confirmation message to the wallet API module 345 (FIG. 3) of the backend server system 140 (FIG. 1). The sale confirmation message may include information indicative of the items purchased, where the items were purchased (e.g., at another store or online), delivery or pickup options, and/or all cash rewards, offers and/or gift cards that were applied in the purchase.

Based on the information contained in the received sale confirmation message, at stage 925, the wallet API module 345 (FIG. 3) may update the store inventory database 320 (FIG. 3) to reflect the items purchased at the store where the customer is present, the items purchased at other stores, and the items purchased online (block 925). In addition, the wallet API module 345 (FIG. 3) may update the customer profile of the customer to indicate which cash rewards, offers, and/or gift cards in the customer's wallet have been used and remove these items from the customer's profile.

Subsequent to performing the actions at steps in block 905 to 925, to the method can continue onto the other stages of the process 400, as indicated by the arrow 440 in FIG. 4. The functions at blocks 405-430, and the related actions shown in FIGS. 5, 6, 7, 8 and 9, may continue as the customer continues to use their wallet account to make further transactions. In various embodiments, a wallet identification or ID can be used to tie together all of the various modules/processes at the point of sale. For example, the wallet ID can be transmitted to a point-of-sale device by scanning, via a device coupled to the POS device, a code or other identifier displayed by the wallet application 230 (FIG. 2). In other embodiments, the wallet ID can be transmitted to the POS device via near field communication and/or other wireless communication. The POS device can retrieve the wallet contents from the customer's profile (stored on the customer profiled database 315 (FIG. 3), including various offers, available payment methods (e.g., gift cards, retailer specific rewards or credit programs, credit cards, debit cards, etc.). The POS device can then apply the contents to the contents of the user's shopping cart to complete a transaction. If the transaction results in additional offers or rewards, the additional offers and rewards can be pushed into the wallet automatically along with any loyalty points earned.

Various embodiments described herein are described in the general context of method steps or processes, which may be implemented in one embodiment by a software program product or component, embodied in a machine/computer-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Various descriptions of given units of functionality that can be performed in accordance with one or more embodiments are provided herein, and may be described as or thought of as modules. Such units of functionality, e.g., a module, might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto.

In the foregoing description, various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects of various embodiments are set out in the independent claims, other aspects of the present disclosure comprise other combinations of features from the described embodiments and/or the dependent claims with the features of the independent claims, and not solely the combinations explicitly set out in the claims.

I/We claim:

1. An omni-channel shopping and mobile payment system, comprising:
a backend server system comprising—
a customer profile database for storing customer identifier information;
a cost estimation module for calculating a total cost of a transaction based on items chosen by a customer for purchase at a retailer;
a loyalty module for determining loyalty rewards earned by the customer based on past purchases at the retailer;
an offers module for determining offers which may be applied to the items chosen by the customer for purchase;
a wallet module for tracking and updating customer specific information, wherein the customer specific information includes:
offers available to the customer,
customer payment information,
customer loyalty rewards, and
the item chosen by the customer for purchase; and
a security module for authenticating and authorizing the customer; and
a mobile wallet application for use on a mobile device and communicatively coupled to the backend server system, wherein the mobile wallet application is configured to cause the mobile device to display, on a display screen of the mobile device:
an itemized list of items chosen by the customer for purchase,
any associated offers and loyalty rewards applicable to the items chosen by the customer for purchase, and
the total price of the transaction including the items chosen by the customer for purchase, the offers, and the loyalty rewards.

2. The omni-channel shopping and mobile payment system of claim 1, further comprising:
a point of sale terminal at a store associated with the retailer, wherein the computer executable instructions of the mobile wallet application cause the mobile device to communicatively couple to the point of sale terminal upon the mobile device scanning a code at the point of sale terminal.

3. The omni-channel shopping and mobile payment system of claim 1, further comprising:
a point of commerce at an online store associated with the retailer, wherein the point of commerce includes a scannable code, and wherein the computer executable instructions of the mobile wallet application cause the mobile device to communicatively couple to the point of commerce upon the mobile device scanning scannable code.

4. The omni-channel shopping and mobile payment system of claim 1 wherein the computer executable instructions of the mobile wallet application cause the mobile device to display a purchase price of a single item upon the mobile device scanning a code associated with the single item, wherein the purchase price of the single item includes offers and loyalty rewards applicable to the single item.

5. An omni-channel shopping and mobile payment method, comprising:
associating, at a server system, offers with a mobile wallet account of a customer, wherein the offers are associated with transactions at a retailer;
determining, at the server system, loyalty rewards based on past activity by the customer with the retailer;
associating, at the server system, the determined loyalty rewards with the mobile wallet account;
receiving, at the server system, indications from multiple shopping channels to add items to a shopping cart associated with the mobile wallet account,
wherein the multiple shopping channels comprise at least one of a mobile device, a point of sale terminal at a store of the retailer, or an online site associated with the retailer;
receiving, at the server system, a checkout indication from a point-of-sale communication device;
calculating, at the server system, a total transaction cost of the items in the shopping cart based on the items in the shopping cart, associated offers, and determined loyalty rewards; and
applying a method of payment associated with the mobile wallet account to the total transaction cost.

6. The method of claim 5, further comprising:
determining if the customer has an existing mobile wallet account and, if so;
authenticating, at the server system, the customer;
updating the mobile wallet account associated with the customer; and
allowing the customer to update the mobile wallet account via mobile wallet application on a mobile device communicatively coupled to the server system.

7. The method of claim 5 wherein associating offers further comprises:
identifying, at the server system, special promotional offers associated with the customer;
identifying, at the server system, special promotional offers based on a geographic location of the customer;
identifying, at the server system, special promotional offers based on the customer's interests;
sending, from the server system, a message listing identified promotional offers to a mobile wallet application on a mobile device of the customer; and
receiving, at the server system, selections of desired promotional offers for use with a current shopping transaction.

8. The method of claim 5 wherein determining loyalty rewards further comprises:
assessing, at the server system, loyalty rewards earned based on past purchase activity of the customer;
updating, at the server system, the mobile account to include newly earned loyalty rewards;
receiving, at the server system, a message from the customer electing how to use the determined loyalty rewards; and
sending, from the server system, a notification to the customer when loyalty rewards are about to expire.

9. The method of claim 5 wherein receiving indications from multiple shopping channels further comprises:
receiving, via a mobile device of the customer or a device associated with the customer, first indications to add items to the shopping cart when the customer is not in a retail store associated with the retailer;
determining, via the mobile device of the customer, that the customer has entered the retail store;
receiving, via at least one of the mobile device of the customer or an in-store communication device, second indications to add items to the shopping cart while the customer is in the retail store, wherein the second indications identify whether the items added to the shopping cart are in the retail store, at another retail store associated with the retailer, and/or available online; and
updating the shopping cart associated with the mobile wallet account based on the received indications.

10. The method of claim 5 wherein receiving a checkout indication further comprises:
receiving a list of all items in the shopping cart associated with the mobile wallet account;
retrieving all offers and loyalty rewards associated with the mobile wallet account;
sending the total transaction cost of items to a point-of-sale device in proximity to the customer; and
receiving a confirmation from the point-of-sale device that the customer has accepted the calculated cost.

11. The method of claim 5 wherein receiving a checkout indication further comprises:
sending the total transaction cost of items to a mobile wallet application on a mobile device associated with the customer;
receiving a confirmation from the mobile device that the customer has accepted the calculated cost;
receiving, from the mobile device, a selection corresponding to one method of payment associated with the mobile wallet account; and
applying the selected method of payment to the total transaction cost.

12. The method of claim 5, further comprising:
receiving, from a point-of-sale device at a retail store, an indication that a mobile wallet application of a mobile device of the customer is in communication with the point-of-sale device; and
updating the shopping cart associated with the mobile wallet account to include items received at the point-of-sale device and selected for purchase by the customer while the customer is in the retail store.

13. The method of claim 5, further comprising:
automatically pushing offers and loyalty rewards issued by the retailer to the mobile wallet account when the offers and loyalty rewards are received.

14. The method of claim 5, further comprising:
communicating, at the server system, with a third-party that issues offers for the retailer; and
automatically pushing offers from the third-party to the mobile wallet account when the offers and loyalty rewards are received.

15. The method of claim 5, further comprising:
receiving, at the server system, offers from an email account associated with the mobile wallet account.

16. The method of claim 5, further comprising:
receiving, from a mobile device associated with the customer, an item identifier associated with an item; and
communicating, to a mobile wallet application on the mobile device, a total cost of the item based on a non-discounted cost of the item, offers in the mobile wallet account, and loyalty rewards in the mobile wallet account.

17. The method of claim 5 wherein the mobile wallet account associated with the customer is a first mobile wallet account associated with a first customer, and wherein the method further comprises:
receiving a request to link the first mobile wallet account with a second mobile wallet account associated with a second customer; and
connecting, at the server system, the first mobile wallet account to the second mobile wallet account such that items in the first mobile wallet account are accessible by the second customer.

18. The method of claim 5 wherein the mobile wallet account associated with the customer is a first mobile wallet account associated with a first customer, and wherein the method further comprises:
receiving a request to send an offer item from the first mobile wallet account to a second mobile wallet account associated with a second customer; and
updating, at the server system, the second mobile wallet account to include the offer item.

19. The method of claim 5, further comprising:
receiving, at the server system, customer information associated with a loyalty account of the customer;
creating the mobile wallet account associated with the customer, and,
updating the mobile wallet account to include loyalty rewards and offers based on transactions made by the customer at the retailer.

20. At least one computer-readable medium carrying instruction, which when executed by a mobile computing device used by a purchaser, performs a mobile payment method, the method comprising:
communicatively coupling the mobile computing device to a server system, wherein the server system is associated with a retailer having multiple, physical stores;
causing the mobile computing device to display, on a display screen of the mobile computing device—
an itemized list of multiple items chosen by the customer for purchase from the retailer,
wherein at least one of the multiple items in the list was previously purchased or selected online by the customer, and
wherein at least one of the multiple items in the list was selected by the purchaser at the one of the multiple, physical stores,
an offer associated with at least one of the multiple items in the list;
a loyalty reward applicable to at least one of the multiple items chosen by the customer for purchase, and
a total price of a transaction, wherein the transaction includes the items chosen by the customer for purchase, the offer, and the loyalty reward.
